(19) United States
(12) Patent Application Publication
(10) Pub. No.: US 2018/0281585 A1
(43) Pub. Date: Oct. 4, 2018

(54) FUEL TANK

(71) Applicant: KAUTEX TEXTRON GMBH & CO. KG, Bonn (DE)

(72) Inventor: Dirk EULITZ, Bonn (DE)

(21) Appl. No.: 15/780,947

(22) PCT Filed: Nov. 8, 2016
(86) PCT No.: PCT/EP2016/077004

§ 371 Date: Jun. 1, 2018

(30) Foreign Application Priority Data
Dec. 3, 2015 (DE) 10 2015 224 195.5

(51) Int. Cl. B60K 15/03; B60K 15/035; B60K 15/04; F02M 37/00

(52) U.S. Cl. CPC B60K 15/03177; B60K 15/035; B60K 15/0406; F02M 37/0082; B60K 2015/03493; B60K 2015/03223; B60K 2015/03388; B60K 2015/0344; B60K 2015/03217

(57) ABSTRACT

The invention relates to a fuel tank for a motor vehicle, comprising a tank body made from thermoplastic with a tank wall which defines a tank volume which can be closed in a substantially fluid-tight manner, with at least one filler opening and with one or more functional insert components which are arranged within the tank volume, at least one blind opening with a single use closure being provided in the tank wall.

### FIELD

The invention relates to a fuel tank for a motor vehicle, comprising a tank body made from thermoplastic with a tank wall which defines a tank volume which can be closed in a substantially fluid-tight manner, with at least one filler opening and with one or more functional insert components which are arranged within the tank volume and which are selected from a group comprising a fuel delivery unit which comprises at least one baffle container and a fuel delivery pump, one or more suction jet pumps, one or more filling level sensors, one or more venting valves and one or more rollover safety valves.

### BACKGROUND

Fuel tanks of this type are usually extrusion blow molded, deep drawn or injection molded from thermoplastic. Such fuel tanks frequently consist of HDPE (high density polyethylene) or are produced on the basis of a thermoplastic of this type. Polyethylene or other polyolefins are not diffusion resistant with respect to hydrocarbons. For reasons of emission protection, the known fuel tanks are as a rule produced from multiple layer plastic extrudates which comprise barrier layers for hydrocarbons. Fundamentally, the aim is to produce the fuel tank with insert components in such a way that as few openings as possible have to be made in the tank wall. Openings in the tank wall are potential leakage paths for hydrocarbons, since the integrity of one or more barrier layers which are integrated into the tank wall can no longer necessarily be ensured in the region of an opening in the tank wall. The tank wall frequently consists of five layer or six layer coextrudates of thermoplastic with an EVOH layer (ethylene vinyl copolymer) which is embedded in adhesion promoter layers and is very thin in relation to the remaining layers of the tank wall. The plies or layers of the tank wall which are cut there are frequently not sealed or sealed merely insufficiently in the region of openings in the tank wall, with the result that hydrocarbons can penetrate between the layers there and can lead to delamination of the layers. Moreover, the barrier layer of the tank wall is breached and interrupted in said region, with the result that leakage paths are produced in this way.

The magnitude of the leakage losses in the order of magnitude of a few milligrams per day is mainly also determined by the size of the openings which are to be provided in the tank wall.

One or more inspection openings which receive what is known as the fuel delivery unit are provided on typical fuel tanks for motor vehicles. In the case of a comparatively large fuel tank, two inspection openings of this type can be provided, for example. The inspection openings have a diameter which corresponds at least to the diameter of a fuel delivery unit which is to be inserted into the fuel tank. A fuel delivery unit of this type as a rule comprises a baffle container, a fuel delivery pump which is integrated into the baffle container, and at least one filling level sensor for the baffle container.

Although modern production methods make it possible for the functional insert components which are to be accommodated in a fuel tank, such as air valves and venting valves, fuel delivery units, filling level sensors, etc., to already be arranged in the tank volume during the production, it has to be possible in the case of a repair to service or replace functional insert components of this type. Therefore, at least one inspection opening is nevertheless to be provided in the tank wall of the fuel tank.

This (as a rule, largest) opening in the tank wall is also the greatest potential leakage source, however.

A fuel tank is known from U.S. Pat. No. 6,179,145 B1. DE 10 2005 032 498 A1 relates to a closure cap of a gasoline tank. DE 198 19 784 A1 relates to a fuel tank having a closure which is to be opened merely in exceptional cases and is configured in one piece together with the fuel tank in the production process.

A tear-off closure instead of a cap as paint animal protection is known from DE 197 03 432 A1.

### SUMMARY

The invention is based on the object of providing a fuel tank of the type mentioned at the outset, which fuel tank is improved with regard to possible hydrocarbon emissions using simple means.

One aspect of the invention relates to a fuel tank for a motor vehicle, the fuel tank comprising a tank body made from thermoplastic with a tank wall which defines a tank volume which can be closed in a substantially fluid-tight manner, with at least one filler opening and with one or more functional insert components which are arranged within the tank volume and which are selected from a group comprising a fuel delivery unit which comprises at least one baffle container and a fuel delivery pump, one or more suction jet pumps, one or more filling level sensors, one or more venting valves and one or more rollover safety valves, at least one blind opening with a single use closure being provided in the tank wall.

The tank body of the fuel tank according to the invention can consist, for example, of a multiple layer extrudate comprising thermoplastic on the basis of HDPE. The tank body can have been produced, for example, by way of extrusion blow molding or deep drawing. The tank body can have been joined together from two injection molded half shells or two deep drawn half shells.

The tank wall preferably comprises structuring outer layers made from HDPE with at least one EVOH barrier layer which is embedded in adhesion promoter layers.

The functional insert components of the fuel tank can be provided in each case in single or multiple form. They are expediently connected to one another functionally, for example by way of fuel lines, electric lines or venting lines which are laid within the tank volume.

A blind opening within the context of the present invention is an opening which is indicated in the tank wall by way of corresponding shaping and can be provided, for example, as a depression in the outer tank wall. Within the context of the invention, a single use closure is to be understood to mean a closure of the blind opening, which closure can be opened only exactly once and is then no longer available for renewed closure of the tank volume.

The invention is based on the recognition that the functional insert components which are provided within the fuel tank can be readily designed for the service life of the fuel tank and/or the motor vehicle, with the result that it is not as a rule required to open the fuel tank again after completion, with the result that an inspection opening would in principle not be required. The maintenance possibility should be provided, however, in particular for use conditions of the motor vehicle, in which high dust loading of the ambient air or contaminated fuel are to be expected.

According to the invention, a fuel tank having a blind opening with a single use closure is therefore provided, which blind opening does not form a breach or aperture of the tank wall. As a result, the fuel tank is completely impermeable in the region of the blind opening. In the region of the blind opening, a barrier layer which is provided in the tank wall or an inner chemical treatment of the tank wall is completely intact, with the result that the leakage potential of the fuel tank is reduced considerably by way of the above-described measures.

In addition, an inspection opening which can be opened and closed again usually requires that metallic closure elements are formed into the tank wall, which closure elements can absorb corresponding holding forces/deformation forces during the closure of the inspection opening. To this end, metallic flange rings which are also called SAE rings are usually integrated into the tank wall. Said flange rings are provided with holding claws or holding clamps which form a part of a bayonet closure and engage over a closure cap. If the inspection opening in the conventional sense is dispensed with, it is likewise no longer necessary to integrate a flange ring of this type into the tank wall, which leads to a considerable weight saving for the fuel tank.

In one preferred variant of the fuel tank of the invention, it is provided that the blind opening is covered and sealed outside the tank volume by way of a closure cap, and that the closure cap is connected releasably to the tank wall.

Said closure cap is as a rule without function, since it has to ensure the sealing action of the fuel tank only in the service or repair case.

The closure cap can be configured in such a way that it stabilizes the tank wall in the region of the blind opening.

The closure cap can be sealed, for example, by way of one or more O-ring seals in the blind opening which is preferably configured as an outer depression in the tank wall. In this case, the closure cap which is integrated into the blind opening stabilizes the blind opening against laterally acting forces.

The closure cap can be provided in such a way that correspondingly configured holding claws or holding clamps or guide faces within the blind openings are not required. As has already been mentioned, the closure cap is without function when the tank wall is intact in the region of the blind opening, apart from the abovementioned stabilizing function.

The blind opening is expediently configured as an integral shaped-out formation of the tank wall.

In one advantageous variant of the fuel tank according to the invention, it is provided that the blind opening has a predetermined break line in the tank wall, which predetermined break line defines a disk-shaped cap which can be detached from the tank wall as a single use closure. In the repair or service case, the cap can be separated or detached from the tank wall, and a re-closure of the inspection opening which is produced in this way then takes place by means of the closure cap which then fulfills the function which is intended for it.

According to the invention, the blind opening is expediently provided with a surround with a thread. The thread is configured, for example, as an internal thread. The closure cap can be configured as a screw cap and can likewise have a thread which is of complementary configuration with respect to the thread of the surround.

The contour of the predetermined break line does not necessarily have to correspond to the contour of the surround. The surround can be, for example, of circularly annular configuration, whereas the contour of the predetermined break line is configured so as to differ therefrom.

In one particularly expedient refinement of the fuel tank according to the invention, it is provided that the cap is provided with a grip tab, with the result that the cap can be detached from the tank wall in a similar manner to the tab on a beverage closure. Here, the cap is preferably delimited completely by a predetermined break line, with the result that the cap can be removed completely from the tank wall. The predetermined break line preferably does not engage into the barrier layer. The predetermined break line can be provided, for example, as a weakened line in an HDPE outer layer.

In one particularly expedient variant of the fuel tank according to the invention, it is provided that the grip tab extends parallel to and partially at a spacing from the cap, and is arranged eccentrically on the cap, with the result that lever forces can be introduced via the grip tab into the predetermined break line which delimits the cap.

As a protective means for the predetermined break line in the case of a possible side impact on the fuel tank, it is provided that the surround is configured as a circumferential thickened bulge which has a greater thickness than the tank wall outside the surround. As a rule, this will be the tank wall of the top floor of the fuel tank, which tank wall can have a thickness, for example, of from 3 to 10 mm. The tank wall expediently has a thickness of approximately 5 mm, and the circumferential bulge can be configured to be approximately twice as thick as the tank wall outside the surround.

As an additional or alternative measure for protecting the predetermined break line against deformation forces which act for instance laterally on the tank wall, one or more beads or corrugations or grooves which run around the surround, act like a spring and absorb deformation forces which are introduced laterally into the tank wall can be provided in the tank wall.

Although it is not necessary in principle in the case of the fuel tank according to the invention to provide a metallic flange ring in the region of the blind opening of the tank wall, this is not ruled out within the context of the invention.

The blind opening having the single use closure within the context of the present invention forms an inspection opening in the tank wall, which inspection opening can be produced once if required, that is to say in the service case or in the repair case. The opening can then be re-closed by way of the closure cap which is provided as a reserve closure.

Leadthroughs which are required, for instance, for an electric connection of the fuel delivery unit and for delivering fuel to the internal combustion engine of the motor vehicle can be provided at a different location in the tank wall. Said leadthroughs are comparatively small in comparison with an otherwise necessary inspection opening.

Overall, the leakage potential of the fuel tank according to the invention has been reduced to approximately 50% of the leakage potential of a comparable conventional fuel tank. Moreover, a weight saving of up to 1 kg is achieved.

### BRIEF DESCRIPTION OF THE DRAWINGS

In the following text, the invention will be described using one exemplary embodiment which is shown in the drawing, in which:

FIG. 1 shows a section through a part of the tank wall of a fuel tank according to the invention in accordance with a first exemplary embodiment in the region of the closed blind opening;

FIG. 2 shows a section which corresponds to FIG. 1 through the tank wall of a fuel tank in the region of the blind opening in accordance with a second exemplary embodiment of the invention;

FIG. 3 shows a section through a part of the tank wall of a fuel tank according to the invention in accordance with a third exemplary embodiment in the region of the closed blind opening; and

FIG. 4 shows a section which corresponds to FIG. 3 through the tank wall of a fuel tank in accordance with a further exemplary embodiment of the invention.

### DETAILED DESCRIPTION

The fuel tank 1 according to the invention is not shown completely in the figures. It comprises a tank body with a tank wall 2 made from thermoplastic.

The tank wall 2 consists of a multiple layer extrudate made from thermoplastics on the basis of polyethylene. Only two layers of the tank wall 2 are shown in outlines in the drawings, but the invention is to be understood in such a way that the tank wall 2 can certainly have a plurality of layers, for example said tank wall 2 can be configured overall with six layers and can comprise two structuring layers and at least one barrier layer which is arranged in between.

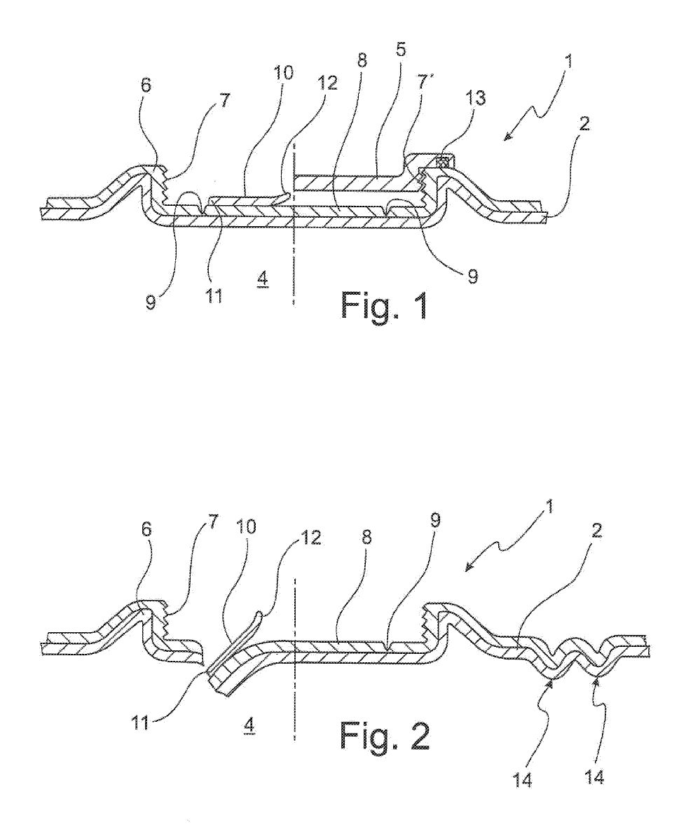

FIG. 1 shows a section through the tank wall 2 in the region of a blind opening 3 which is configured as an integral shaped-out formation of the tank wall. The tank wall 2 encloses a tank volume 4 which is faced by the inner side of the tank wall 2. On the side which faces away from the tank volume 4, the blind opening 3 is configured as a depression of the tank wall 2. The blind opening 3 therefore forms a blind bore in the outer side of the tank wall 2. On the outer side of the tank wall 2, the blind opening 3 is closed tightly by means of a screw cap 5. The blind opening 3 is delimited by way of a surround 6 which is provided with a thread 7 which interacts with a corresponding thread 7′ of the screw cap 5.

According to the invention, the blind opening 3 is configured as a single use closure of the fuel tank 1, the single use closure being formed by way of a disk-shaped cap 8 which is defined by way of a completely circumferential predetermined break line 9 in the tank wall 2.

The blind opening 3, the surround 6, the thread 7 of the surround and the screw cap 5 are rotationally symmetrical and circular in the plan view. A grip tab 10 is fastened to the cap 8 on that side of the cap 8 which faces away from the tank volume 4. The grip tab 10 comprises a first end 11 which forms the root region of the grip tab 10 and a second end 12 which is configured as a grip end and projects from the outer face of the cap 8, with the result that it can be reached under there by way of a finger of the hand of an operator. The grip tab 10 is arranged eccentrically on the cap 8 in such a way that the first end 11 of the grip tab 10 adjoins the predetermined break line 9, with the result that, if the second end 12 of the grip tab is reached under, as shown in outlines in FIG. 2, lever forces are introduced into the predetermined break line 9 in such a way that first of all the cap 8 can be pressed in downward in the direction of the tank volume 4, with the result that the predetermined break line 9 tears. The cap 8 can then be separated completely from the tank wall 2 by way of pulling on the grip tab 10.

As has already been mentioned at the outset, the fuel tank is commissioned with the closed blind opening 3. In this state, the tank volume 4 in the region of the blind opening 3 is closed. The cap 8 is connected fixedly to the tank wall 2, and the depression which is formed by way of the blind opening 3 in the tank wall 2 is covered by way of the screw cap 5. The screw cap 5 is sealed against a circumferential sealing face of the surround 6 via a circumferential elastomer seal 13. In this state, as shown in FIG. 1, for example, the screw cap 5 is substantially without a function.

In a service case which is not to be assumed, the screw cap 5 would have to be opened. The cap 8 would have to be released from the tank wall 2 via the grip tab 10, with the result that an inspection opening which is accessible from the outside is then formed in the tank wall 2.

After the maintenance has been carried out, the screw cap 5 would have to be inserted again into the opening which is produced in this way, the screw cap 5 then actually being given the function of the sealing of the tank volume 4.

FIG. 2 shows a second exemplary embodiment of the invention, in which identical components are provided with identical designations. FIG. 2 at the same time shows the partially open state of the cap 8 with destruction of the tank wall 2 in the region of the predetermined break line 9. The screw cap 5 which is also provided in this exemplary embodiment of the invention is not shown in FIG. 2 also for reasons of simplification.

The exemplary embodiment according to FIG. 2 differs from that in FIG. 1 in that two circumferential beads 14 which are arranged at a spacing from one another are provided in the tank wall 2, which beads 14 enclose the surround 6 completely. FIG. 2 shows only one side of the tank wall with the beads 14. The beads are arranged in each case in a circular completely circumferential manner at a spacing from the surround 6 and act as springs which absorb deformation forces which are possibly introduced laterally into the tank wall 2, and therefore prevent the predetermined break line 9 from being loaded.

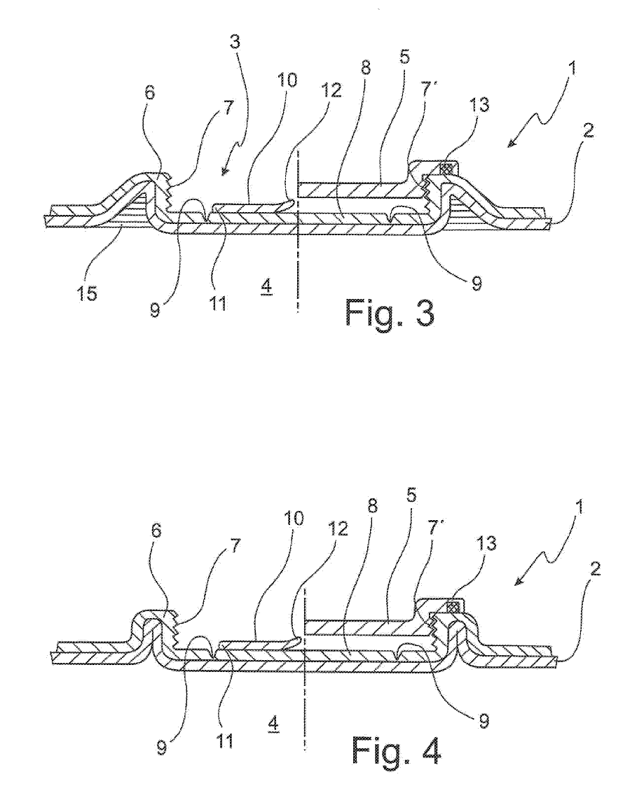

The exemplary embodiment according to FIG. 3 corresponds approximately to that according to FIG. 1, with the difference that an annular space which is provided in the region of the surround 6 in the tank wall 2 on the side which faces the tank volume 4 is filled by a supporting ring 15. The supporting ring 15 forms a mechanical stabilization of the surround 6 in such a way that the blind opening 3 or the predetermined break line 9 is kept free from any impact-induced lateral forces. The supporting ring 15 can be configured as a metallic supporting ring. As an alternative, the supporting ring 15 can also be configured from a comparatively strong thermoplastic. In this context, a strong thermoplastic can be understood to mean, for example, a glass fiber reinforced polyolefin. Otherwise, identical components are provided with identical designations in the exemplary embodiment according to FIG. 3 as in the remaining exemplary embodiments.

The exemplary embodiment according to FIG. 4 differs from that in FIG. 1 to the extent that the surround 6 is formed by way of a fold of the tank wall 2, that is to say the tank wall 2 is configured to be twice as thick in the region of the surround 6 as in the remaining region of the tank wall 2, and forms a bulge-like thickened portion there. Otherwise, the exemplary embodiment according to FIG. 4 corresponds to that in FIG. 1. Identical components are provided with identical designations.

### LIST OF DESIGNATIONS

1 Fuel tank
2 Tank wall
3 Blind opening
4 Tank volume
5 Screw cap
6 Surround
7 Thread of the surround
7′ Thread of the screw cap
8 Cap
9 Predetermined break line
10 Grip tab
11 First end of the grip tab
12 Second end of the grip tab
13 Elastomer seal
14 Beads
15 Supporting ring

What is claimed is:

1-10. (canceled)

11. A fuel tank for a motor vehicle, comprising a tank body made from thermoplastic with a tank wall which defines a tank volume which can be closed in a substantially fluid-tight manner, with at least one filler opening and with one or more functional insert components which are arranged within the tank volume and which are selected from a group comprising a fuel delivery unit which comprises at least one baffle container and a fuel delivery pump, one or more suction jet pumps, one or more filling level sensors, one or more venting valves and one or more rollover safety valves, at least one blind opening with a single use closure being provided in the tank wall, the blind opening being covered and sealed outside the tank volume by way of a closure cap, and the closure cap being connected releasably to the tank wall, characterized in that the blind opening has a surround with an internal thread, and in that the surround is configured as a circumferential bulge which has a greater thickness than the tank wall outside the surround.

12. The fuel tank as claimed in claim 11, wherein the blind opening is configured as an integral shaped-out formation of the tank wall.

13. The fuel tank as claimed in claim 11, wherein the blind opening has a predetermined break line in the tank wall, which predetermined break line defines a disk-shaped cap which can be detached from the tank wall as a single use closure.

14. The fuel tank as claimed in claim 13, wherein the closure cap is configured as a screw cap and has a thread which is of complementary configuration with respect to the thread of the surround.

15. The fuel tank as claimed in claim 13, wherein the cap is provided with a grip tab.

16. The fuel tank as claimed in claim 15, wherein the grip tab extends parallel to and partially at a spacing from the cap and is arranged eccentrically on the cap, with the result that lever forces can be introduced via the grip tab into the predetermined break line which delimits the cap.

17. The fuel tank as claimed in claim 11, wherein the tank wall has at least one bead which runs around the surround.
